(19) United States
(12) Patent Application Publication
(10) Pub. No.: US 2003/0216902 A1
(43) Pub. Date: Nov. 20, 2003

(54) Chip development system with built-in function library

(76) Inventor: Hwang-Kyu Lim, Kyunggi-do (KR)

Correspondence Address: HARNESS, DICKEY & PIERCE, P.L.C., P.O. BOX 8910, RESTON, VA, 20195, US

(21) Appl. No.: 10/383,606

(22) Filed: Mar. 10, 2003

(30) Foreign Application Priority Data
May 20, 2002 (KR) 2002-27740

(51) Int. Cl. G06F 17/50

(52) U.S. Cl. 703/14

(57) ABSTRACT

A chip development system includes debugging software for simulating chip operation. A function library is also included for processing chip functions in the form of software, the function library being driven by the debugging software.

This U.S. nonprovisional patent application claims priority under 35 U.S.C. § 119 of Korean Patent Application 2002-27740 filed on May 20, 2002, the entire contents of which are hereby incorporated herein by reference.

### BACKGROUND OF THE INVENTION

1. Field of the Invention

The present invention generally relates to chip development systems.

2. Discussion of the Related Art

Smart cards are being used in an increasingly wide variety of applications. One such application is the use of smart cards to provide credit/debit payment capability for mass transit users. Smart cards have found applications in many other areas including pay phones, health care, banking identity and access, pay television, gaming, metering and vending. Retail businesses utilize smart cards to encourage return business, such as the use of smart cards to obtain a discount on merchandise or to gain points that are redeemable for cash or merchandise.

Smart cards generally include one or more integrated circuit (IC) located within the body of the card to receive and store information. The ICs can be read-only or have read/write capability. Reusable smart cards with read/write capability allow users to add time or value to payment-type smart cards, thus avoiding the inconvenience of having to carry currency, or, in the case of mass transit, exact change, for each usage. The smart card may also contain an interface, which will depend on whether the smart card is a contact-type or contactless smart card. Contactless cards may contain an antenna structure for communication with an RF source, and may also include circuitry adapted for deriving operating power from the RF signal.

Known smart card development devices typically include the use of an emulation device. In general, such an emulation device includes hardware with a microcomputer development system (MDS) and an emulation board. An application environment is typically interfaced to the emulation device. The MDS corresponds to and functions as a CPU core. A target chip for evaluation may be inserted into the emulation board. The application environment is implemented with various software programs that may facilitate use of the emulation device and for testing a target chip.

FIG. 1 illustrates a conventional smart card development system. As is illustrated, the development system includes both software (S/W) 100 and hardware (H/W) 110. The S/W 100 includes an assembler 120, a compiler 130, a linker 140, a debugger 150, and a simulator 160. The H/W 110 includes an MDS 170 and an emulation board 180 into which a target chip 190 may be inserted. The emulation board 180 is connected to a terminal 200 via an RS-232C interface card 202. The MDS 170 is a microprocessor that controls/verifies an operation of the target chip 190.

Because an operation of most conventional smart cards is specifically determined and unmodifiable by semiconductor manufacturing processes implemented to develop the chips used on the cards, conventional development systems designed with a combination of software and hardware can sufficiently handle the one-time programming/testing required to operationally activate smart cards. However, as smart card technology continues to improve and develop, the hardware portions of the conventional development systems often need to be redeveloped and manufactured, at a potentially high cost.

### SUMMARY OF THE INVENTION

An exemplary embodiment of the present invention provides a chip development system.

An exemplary embodiment of the present invention provides a chip development system with a built-in function library.

An exemplary embodiment of the present invention provides chip development system including software for simulating chip operation, and a function library for processing chip functions, where the function library may be driven by the debugging software.

Another exemplary embodiment of the present invention provides a chip development method, that simulates chip functionality using software; and processes chip functions in software form.

Further scope of applicability of exemplary embodiments of the present invention will become apparent from the detailed description given hereinafter. However, it should be understood that the detailed description and specific examples, while indicating exemplary embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 illustrates a conventional smart card development system.

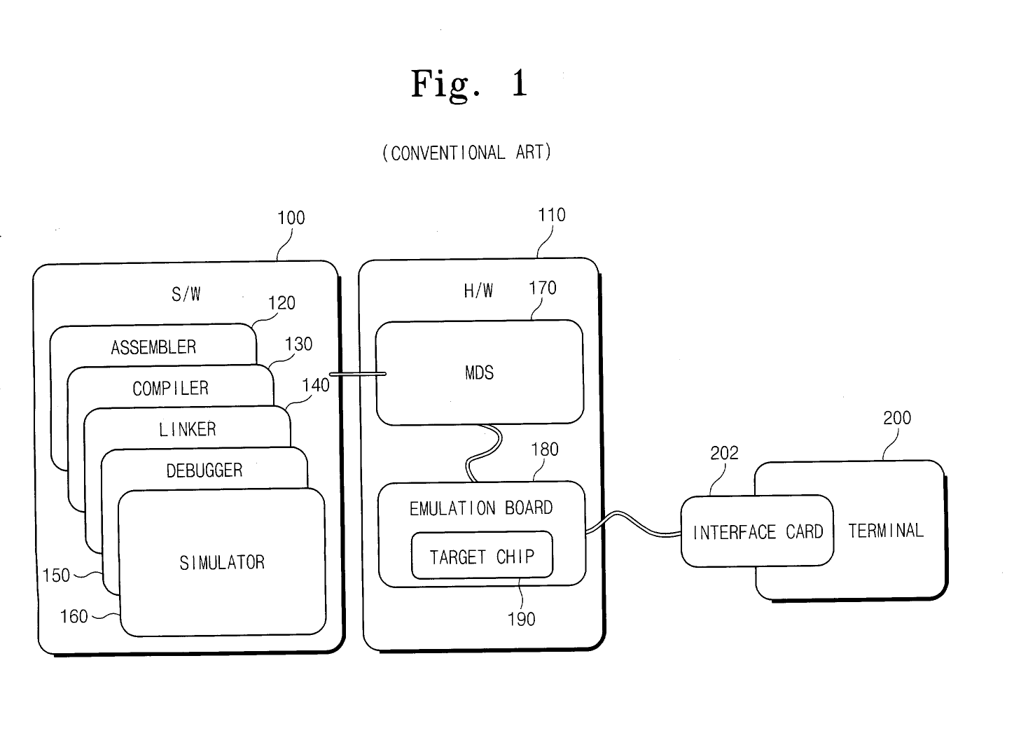

FIG. 2 illustrates a smart card development system in accordance with an exemplary embodiment of the present invention.

### DETAILED DESCRIPTION OF THE EXEMPLARY EMBODIMENTS

Reference will now be made in detail to the exemplary embodiments of the present invention, examples of which are illustrated in the accompanying drawings. However, the present invention is not limited to the exemplary embodiments discussed herein.

Hereinafter, a chip development system will be described in detail. The chip development system may be used as a smart card development system. However, the chip development system may also be used for developing and processing various other chips, which may or may not be used in conjunction with smart cards.

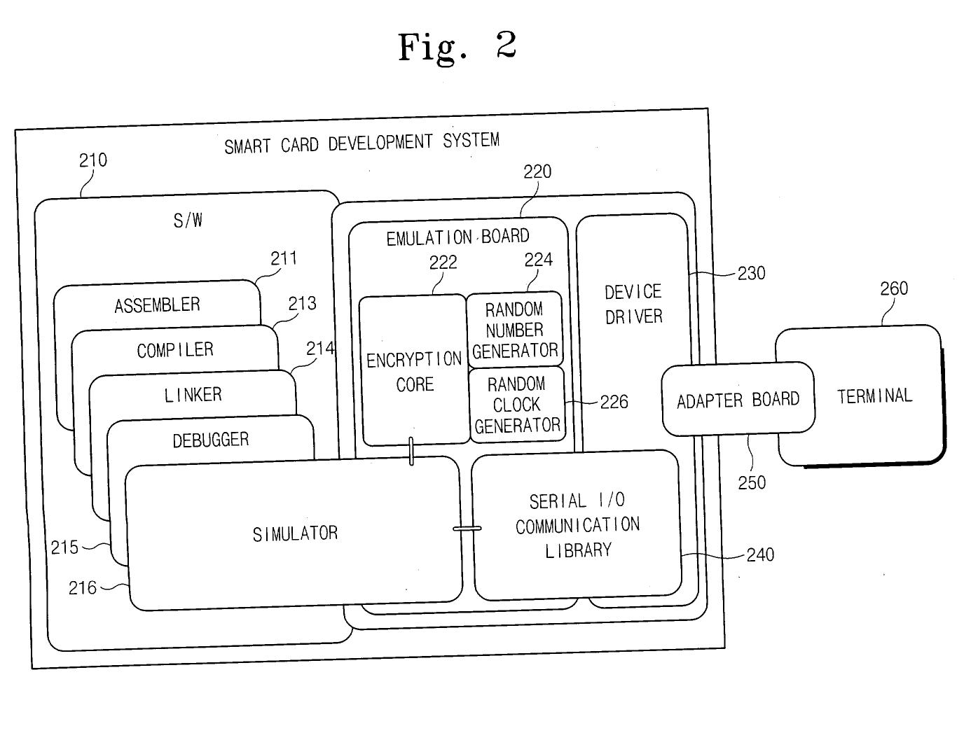

FIG. 2 illustrates a smart card development system in accordance with an exemplary embodiment of the present invention. Referring to FIG. 2, a smart card development system according to an exemplary embodiment of the present invention may include a debugging software 210 for simulating an operation of a smart card, a function library 220 in which smart card functions are processed in a form of software, a device driver 230 for driving the function library 220, a serial I/O communication library 240 for providing a communication protocol algorithm between the debugging software 210 and the function library 220, and a card adapter board 250 for supporting a communication with a terminal 260 that manipulates the smart card.

The debugging software 210 may include an assembler 211, a compiler 213, a linker 214, a debugger 215 and a simulator 216 for executing code developed using the debugging software 210. The debugging software 210 may be used to compile and debug files of the function library 220.

The assembler 211 may function to translate assembly language program into binary machine code. The assembler 211 remembers values of symbols and addresses of data elements. Unlike high level language, each assembly language instruction corresponds to one machine instruction.

The compiler 213 may be a computer program that reads source files of another program to produce a binary file, which is required for execution by a computer. The source files describe the program using a computer language such as C, C++, COBOL or the like. The binary file produced by the compiler 213 may contain a series of binary machine instructions for a particular type of computer. Moreover, the compiler 213 may generate diagnostic messages when it detects errors in the source files. The compiler 213 is distinguished from the assembler 211 by the fact that each input statement does not, in general, correspond to a single machine instruction or fixed sequence of instructions. A compiler may support such features as automatic allocation of variables, arbitrary arithmetic expressions, control structures such as FOR and WHILE loops, variable scope, input/output operations, higher-order functions and portability of source code.

A source file may contain compiler directives that may cause other source files to be included. A compilation unit (not shown) may be a single source program file given to a compiler, plus all the source program files included directly or indirectly by that file. A binary file can contain machine instructions from one or more compilation units, and a compilation unit can come from multiple source files. Sometimes the machine instructions of a single compilation unit are saved in a separate binary file, called an object file. Object files are then combined by the linker 214 to create a final binary file.

Once a program has been compiled and linked, it may be executed and then debugged. Because logical errors, also known as “bugs,” are introduced by programmers, errors may be detected and understood using the debugger 215. After correcting any discovered errors and recompiling, the debugger 215 may be used to confirm that the errors have been eliminated. Other uses for the debugger 215 include inspecting executing programs to understand their operation, monitoring memory usage, instrumenting and testing programs, verifying the correctness of program translation by the compiler 213, and verifying the correctness of operation of other dependent programs.

The function library 220 includes an encryption core 222 in which information data for use with a smart card may be stored, a random number generator 224 for randomizing a key for use with a smart card, and a random clock generator 226 for generating a clock for synchronizing the information data for use with a smart card.

The encryption core 222 may include a crypto library having an algorithm for encoding documents or file information. The encryption core 222 may generate a symmetric key and an asymmetric key. The encryption core 222 may generate encryption keys according to the Data Encryption Standard (DES), the RSA encryption standard, Elliptical Curve Cryptology (ECC), among others known to one of ordinary skill in the art. The encryption core 222 is not limited to the indicated encryption techniques. The random number generator 224 and the random clock generator 226 may be randomly operated so as to unpredictably encipher information data.

According to an exemplary embodiment of the present invention, the function library 220 generally replaces the conventional hardware of the MDS and emulation board. Therefore, as changes and improvements in smart card technology occur, the development system in accordance with the exemplary embodiments of the present invention may be updated as needed. Moreover, since a series of processes required to mount or remove a smart card are eliminated, smart card emulation may occur in an expeditious manner.

According the exemplary embodiments of the present invention, chip operation may be verified using the function library 220. In particular, the function library 220 may process chip functions in the form of software. Therefore, it is possible to freely and easily verify and develop chip operation without the limitations associated with hardware based development systems. This potentially reduces the amount of time required to develop chip operation.

Exemplary embodiments of the present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A chip development system, comprising:
software for simulating chip operation; and
a function library for processing chip functions, the function library being driven by the software.

2. The chip development system of claim 1, wherein the software includes at least one of an assembler, a compiler, a linker, a debugger and a simulator.

3. The chip development system of claim 1, wherein the function library includes an encryption core for storing the chip functions, a random number generator for randomizing a key, and a random clock generator for generating a synchronization clock.

4. The chip development system of claim 3, wherein the function library includes interface functionality for supporting communication with a terminal.

5. The chip development system of claim 1, further comprising a terminal interfaced to the chip development system, the terminal for allowing operational manipulation of the system.

6. The chip development system of claim 1, further comprising a communication library providing a communication protocol algorithm for facilitating communication between the debugging software and the function library.

7. The chip development system of claim 1, further comprising a device driver for driving the function library.

8. The chip development system of claim 1, wherein the chip functions are in software form.

9. A chip development method, comprising:
simulating chip functionality using software; and
processing chip functions in software form.

10. The chip development method of claim 9, wherein the software includes at least one of an assembler, a compiler, a linker, a debugger and a simulator.
